(19) United States
(12) Patent Application Publication
(10) Pub. No.: US 2004/0219940 A1
(43) Pub. Date: Nov. 4, 2004

(54) Call setup method and system for push-to-talk service in a cellular mobile communication system

(76) Inventors: Dong-Koon Kong, Suwon-si (KR); Tae-Won Kim, Yongin-si (KR); Hong-Sung Chang, Suwon-si (KR); Jong-Bum Pyo, Yongin-si (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/834,101

(22) Filed: Apr. 29, 2004

(30) Foreign Application Priority Data
Apr. 30, 2003 (KR) 27634/2003

(51) Int. Cl. B62K 7/00; H04Q 7/20

(52) U.S. Cl. 455/518; 455/450; 455/509

(57) ABSTRACT

A method and system for setting up a call for a Push-to-Talk (PTT) service in a cellular mobile communication system including at least two user agents, each of the user agents serving as a talker or a listener. A talker transmits a first PTT request message for starting a PTT call to a PTT server over a reverse common channel, and sets up a traffic channel to a corresponding radio access network. The PTT server transmits a second PTT request message to a listener in a dormant state over a forward common channel, and the listener sets up a traffic channel to a corresponding radio access network in response to the second PTT request message. The listener sets up the traffic channel, and transmits a PTT confirm message to the PTT server over a reverse common channel in response to the second PTT request message. The talker transmits voice packets to the listener over the set traffic channel via the PTT server.

### PRIORITY

This application claims priority under 35 U.S.C. § 119(a) to an application entitled “Call Setup Method for Push-to-Talk Service in a Cellular Mobile Communication System” filed in the Korean Intellectual Property Office on Apr. 30, 2003 and assigned Ser. No. 2003-27634, the entire contents of which are incorporated herein by reference.

### BACKGROUND OF THE INVENTION

1. Field of the Invention

The present invention relates to a cellular mobile communication system and method. In particular, the present invention relates to a method and system for setting up a call for a Push-to-Talk (PTT) service.

2. Description of the Related Art

Mobile communication systems can typically be classified into a system for supporting a voice service and a system for supporting a data service according to their uses. A typical example of such systems includes a Code Division Multiple Access (CDMA) system. A current CDMA system supporting only a voice service follows Interim Standard-95 (IS-95) which is incorporated herein by reference. With the progress of communication technology, a mobile communication system is being developed for supporting a high-speed data service. For example, a first generation CDMA2000 (referred to as CDMA2000 1X) standard has been proposed to support both voice service and data service.

With the development of mobile communication systems, users are demanding multimedia service, broadcast service and a Push-to-Talk (PTT) service as well as the existing end-to-end (or person-to-person) voice call service, using a user agent (UA) such as a cellular phone and a Personal Communication System (PCS) phone.

A PTT call service refers to a service in which an end-to-end or inter-group call path is established in a network capable of providing a PTT service and then a call is performed through the established call path. A user can receive a PTT service by calling the PTT service after selecting groups of colleagues or friends, or a user or a group of normal users desiring a voice call. The user(s) or group(s) are displayed in a UA after log-in. Particularly, unlike a normal telephone service, the PTT service enables a user to start talking by pushing a PTT button and implements an economical group call with three or more participants.

FIG. 1 is a block diagram of a network configuration for providing a PTT service in a CDMA2000 1X system. Referring to FIG. 1, a UA 10 for supporting the PTT service has a PTT button (not shown) mounted therein, and can implement a radio frequency connection according to a CDMA2000 1X standard. A CDMA2000 1X radio access network (RAN) 20 exchanges packets with the UA 10 through a radio channel. A packet data service node (PDSN) 30 connects the radio access network 20 to an Internet protocol (IP)-based packet communication network 40. A PTT server 50, connected to the packet communication network 40, manages a PTT session and relays a voice packet from a talker to a listener.

In such a PTT service network, a protocol for the PTT service such as a session initiation protocol (SIP) can be used for signaling transmission, and a real-time transport protocol (RTP) can be used for real-time voice packet transmission. The SIP, an end-to-end or server-client signaling protocol, is used to exchange necessary session information before a start of a call and to remove the session information after an end of the call.

However, the conventional technology has not provided a detailed method for establishing a call for the PTT service and assigning a traffic channel in a CDMA 1X system. Accordingly, there is a demand for a method and system for efficiently establishing a traffic channel while reducing a call setup time during a group call by the PTT service.

### SUMMARY OF THE INVENTION

It is, therefore, an object of the present invention to provide a method and system for starting a Push-to-Talk (PTT) call service in a dormant state in a cellular mobile communication system.

It is another object of the present invention to provide a signaling method and system for performing a fast call setup for a PTT call service in a cellular mobile communication system.

The above and other objects are achieved by providing a method and system for establishing a call for a Push-to-Talk (PTT) service in a cellular mobile communication system including at least two user agents, each of the user agents serving as a talker or a listener. In the method and system, a talker transmits a first PTT request message for initiating a PTT call to a PTT server over a reverse common channel, and sets up a traffic channel to a corresponding radio access network. The PTT server transmits a second PTT request message to a listener in a dormant state over a forward common channel, and the listener sets up a traffic channel to a corresponding radio access network in response to the second PTT request message. The listener sets up the traffic channel, and transmits a PTT confirm message to the PTT server over a reverse common channel in response to the second PTT request message. The talker transmits voice packets to the listener over the set traffic channel via the PTT server.

The above and other objects are achieved by providing a method and system for setting up a call for a Push-to-Talk (PTT) service in a cellular mobile communication system including at least two user agents, each of the user agents serving as a talker or a listener. In the method and system, a talker transmits a first PPT request message for starting a PTT call, carried by an origination message or a reconnect message, to a PTT server over a reverse common channel to set up a traffic channel to a corresponding radio access network. The PTT server transmits a second PTT request message to a listener in a dormant state over a forward common channel, and the listener sets up a traffic channel to a corresponding radio access network in response to the second PTT request message. After setting up the traffic channel, the listener transmits a PTT confirm message carried by an origination message or a reconnect message to the PTT server over a reverse common channel in response to the second PTT request message. The talker transmits voice packets to the listener over the set traffic channel via the PTT server.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram of a network configuration for providing a Push-to-Talk (PTT) service in a Code Division Multiple Access 2000 First Evolution (CDMA2000 1X) system;

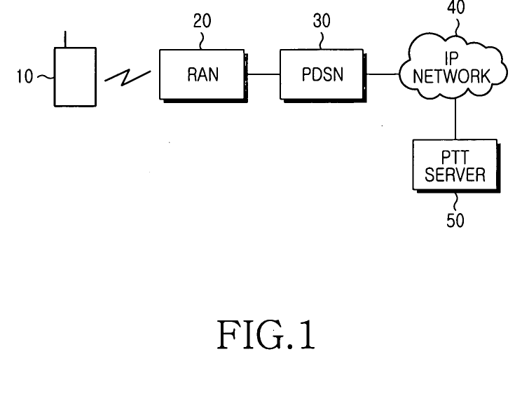

FIG. 2 is a message flow diagram illustrating a procedure for performing a first-type PTT service through a traffic channel according to an embodiment of the present invention;

FIG. 3 is a message flow diagram illustrating a procedure for performing a second-type PTT service through a traffic channel according to an embodiment of the present invention;

FIG. 4 is a message flow diagram illustrating a procedure for performing a first-type PTT service through a common channel according to a first embodiment of the present invention;

FIG. 5 is a message flow diagram illustrating a procedure for performing a second-type PTT service through a common channel according to the first embodiment of the present invention;

FIG. 6 is a message flow diagram illustrating a procedure for performing a first-type PTT service through a common channel according to a second embodiment of the present invention;

FIG. 7 is a message flow diagram illustrating a procedure for performing a second-type PTT service through a common channel according to the second embodiment of the present invention;

FIG. 8 is diagram illustrating a format of an origination message according to the second embodiment of the present invention; and

FIG. 9 is a diagram illustrating a format of a reconnect message according to the second embodiment of the present invention.

It should be understood that in the drawings, like reference numbers refer to like features and structures.

### DETAILED DESCRIPTION OF THE PREFERRED EMBODIMENTS

Several embodiments of the present invention will now be described in detail with reference to the annexed drawings. In the following description, a detailed description of known functions and configurations incorporated herein has been omitted for conciseness. The present invention is described using examples. However, it should be appreciated by those skilled in the art that the present invention is not limited to the examples shown.

In providing a group call service, specifically, a Push-to-Talk (PTT) call service, using a radio network, the present invention aims to rapidly set up a traffic channel for a PTT call while reducing call setup-related latency. Particularly, in the embodiments of the present invention, when a UA requests a PTT service over a reverse radio link, an initial PTT request message is transmitted in the form of a short data burst (SDB) and a radio traffic channel is established between a user agent (UA) such as a cellular phone and a Personal Communication System (PCS) phone and a radio access network before a response thereto is received.

A detailed description will now be made of the present invention with reference to a mobile communication system using a Code Division Multiple Access 2000 First Evolution (CDMA2000 1X standard and a CDMA2000 1X-based radio interface standard. However, it should be understood by those skilled in the art that an efficient call setup technology for a PTT service, using the present invention, can be applied to other mobile communication systems having similar technical backgrounds and channel formats without departing from the spirit and scope of the present invention.

When a group call is connected with a talker device (hereinafter referred to as a talker) and a plurality of listener devices (hereinafter referred to as a listener) through a CDMA2000 1X system supporting a PTT service, a procedure for performing signaling in a dormant state can be divided into two types.

In a first type, if a user pushes a PTT button of a UA serving as a talker, the UA serving as a talker sends a PTT service request to a PTT server in order to transmit voice packets to selected listeners, and the PTT server preferentially sends a response to the requested listener. Thereafter, the PTT server pages listeners and reactivates listeners in a dormant state. Here, “reactivation” refers to causing listeners in a dormant state to reconnect with a corresponding radio access network through a radio channel. When voice packets are received at the PTT server from the talker, if the listeners are not ready to receive the voice packets yet, the voice packets are buffered in the PTT server or other network nodes located between the talker and the listeners.

In a second type, if a user activates a UA serving as a talker by pushing a PTT button, the UA serving as a talker sends a PTT service request to a PTT server in order to transmit voice packets to selected listeners, and the PTT server first pages listeners and reactivates the listeners before sending a response to the talker. If responses indicating completion of their reactivations are received from the listeners, the PTT server sends a response to the talker allowing the talker to transmit the voice packets.

When there is a packet call connected to a UA, signaling messages related to a request and a response for the PTT service are transmitted and received over a traffic channel. However, if there is no packet call connected to a UA, the UA establishes a traffic channel for a PTT call and then, transmits and receives PTT signaling messages over the established traffic channel. In order to set up a PTT call in a dormant state, a talker should first perform a reactivation procedure.

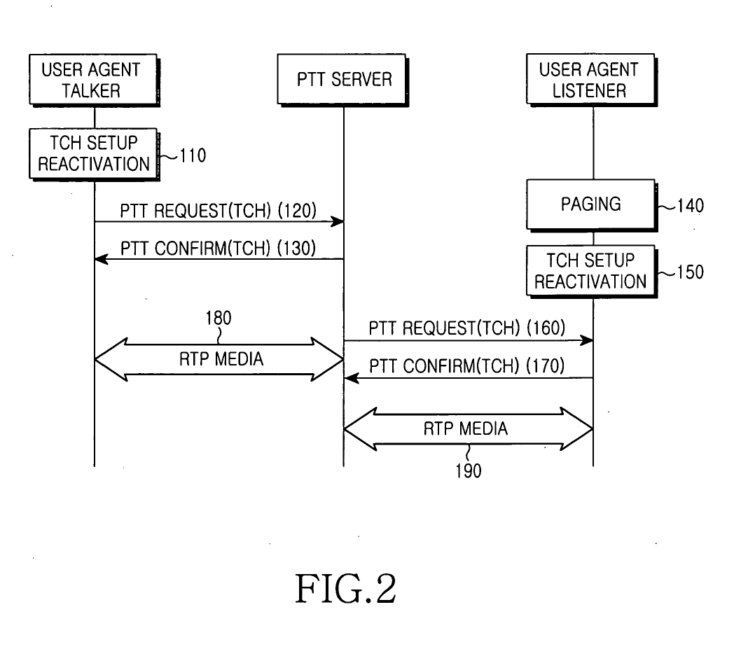

FIG. 2 is a message flow diagram illustrating a procedure for performing the first-type PTT service through a traffic channel according to an embodiment of the present invention. Although such network elements as a radio access network (RAN) and a packet data service node (PDSN) are not illustrated herein for the convenience of explanation, it should be understood that a talker and listeners access a PTT server through their corresponding radio access networks and PDSNs.

In addition, it should be noted that the talker and the listeners are all in a dormant state where they have stored therein connection information necessary for assignment of traffic channels and a network connection. In the dormant state, radio traffic channels are released when there is no burst traffic for a data service, and only the information related to reconnection is stored in a UA and a radio access network.

Referring to FIG. 2, in step 110, a talker sets up a traffic channel (TCH) to a PTT server via a corresponding radio access network through a reactivation procedure in response to a push of a PTT button by a user. After setup of the traffic channel, the talker transmits in step 120 a PTT request message “Can I get floor?” by way of example to the PTT server over the established traffic channel. In response, the PTT server transmits in step 130 a PTT confirm message “Grant/Deny” by way of example to the talker over the traffic channel.

After generating a grant tone to the talker by transmitting the PTT confirm message in step 130, the PTT server pages listeners in step 140 in order to perform a reactivation procedure. The paging is achieved by transmitting a paging message to listeners via at least one radio access network servicing the listeners in response to a request by the PTT server.

If traffic channels are set up between the PTT server and the listeners in step 150 by the reactivation procedure, the PTT server transmits in step 160 a PTT request message “announce” by way of example to the listeners over the traffic channels, and in response, the listeners send in step 170 a PTT confirm message “I am ready” by way of example to the PTT server over the traffic channels. Then the talker exchanges voice packets with the listeners according to the RTP in steps 180 and 190.

Until the listeners complete the setup of their traffic channels from a dormant state, voice packets transmitted from the listeners by the RTP are buffered in the PTT server or other network elements in step 180. If setup of the traffic channels between the PTT server and the listeners is completed, the buffered voice packets and their following voice packets are transmitted to the listeners. If there is no response to the paging from the listeners in step 140 after the PTT server generates a grant tone to the talker, the buffered voice traffics are discarded and the PTT server releases a PTT call to the listeners.

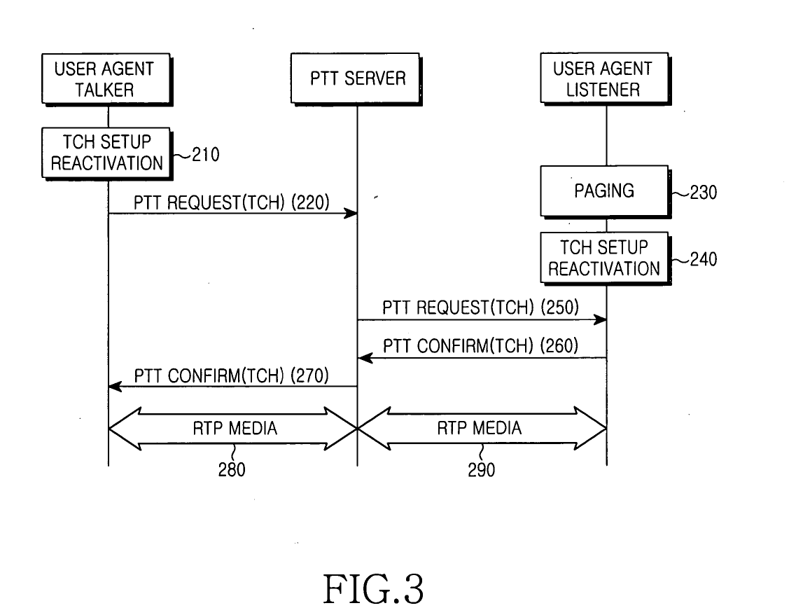

FIG. 3 is a message flow diagram illustrating a procedure for performing the second-type PTT service through a traffic channel according to an embodiment of the present invention. Referring to FIG. 3, in step 210, a talker sets up a traffic channel to a PTT server via a corresponding radio access network through a reactivation procedure in response to a push of a PTT button by a user. After setup of a traffic channel, the talker transmits in step 220 a PTT request message “Can I get floor?” by way of example to the PTT server over the set traffic channel. In step 230, the PTT server first pages listeners before generating a grant tone to the talker, and then performs a reactivation procedure.

If traffic channels are set up between the PTT server and the listeners by the reactivation procedure in step 240, the PTT server transmits in step 250 a PTT request message “announce” to the listeners over the traffic channels, and in response, the listeners send in step 260 a PTT confirm message “I am ready” to the PTT server over the traffic channels. Then, in step 270, the PTT server transmits a PTT confirm message “Grant/Deny” to the talker and generates a grant tone to the talker. When the above procedures are completed, voice packets are exchanged between the talker and the listeners by the TRP in steps 280 and 290.

In the case of the second-type PTT service stated above, although the talker receives a grant tone late compared to the first-type PTT service, it can avoid an unnecessary PTT call release procedure occurring in the absence of a response from the listeners because it has already received a response from the listeners.

In FIGS. 2 and 3, because PTT signaling messages are transmitted over a traffic channel, latency related to the traffic channel setup request, the response and the paging inevitably occurs. The PTT service increases in its effective value, as a setup time from a point where a user pushes a PTT button to a point where the user hears a grant tone indicating that he or she are allowed to talk, is shorter.

However, in the method described above, about 2 to 3 seconds are required until a talker in a dormant state sets up a traffic channel by a reactivation procedure, 1 to 3 seconds are required until PTT signaling messages are delivered to listeners, and about 2 to 3 seconds are required when the listeners set up their traffic channels. Therefore, a long time is required for PTT call setup, preventing an efficient PTT call service.

A description will now be made of more preferable embodiments for providing a PTT service in a radio access network supporting a short data burst (SDB). As is well known, the “short data burst” refers to technology for transmitting a limited amount of data (mainly text) over a common channel for signaling and control between a UA in a dormant state and a radio access network, i.e., a common channel or a paging/access channel based on a 1XEVDO Release A standard which is incorporated herein in its entirety. Such a short data burst service is supported in most cellular mobile communication systems including a CDMA communication system for its advantage that it can transmit and receive data without a burden on assignment of traffic channels.

In the embodiments of the present invention, PTT signaling (request/confirm) messages are carried by forward and reverse common channels, and here, the PTT signaling messages are made in an SDB format. Although the embodiments of the present invention will be described using a forward common control channel (F-CCCH) and a reverse extended access channel (R-EACH), it should be understood that the PTT signaling messages are transmitted using a new common channel defined by the 1XEVDO Release A standard or a paging/access channel.

According to a first embodiment of the present invention, a PTT terminal (or UA) transmits a PTT request message carried by a Data Burst Message (DBM) message available for fast transmission over a common channel instead of a traffic channel, and previously transmits an origination message or a reconnect message while waiting for a response to the PTT request message, thereby setting up a traffic channel for transmission of PTT voice traffics.

According to a second embodiment of the present invention, a PTT terminal (or UA) transmits a PTT request message carried by an origination message or a reconnect message over a common channel, and sets up a traffic channel for transmission of PTT voice packets.

Now, a description of the first and second embodiments of the present invention will be separately made for the first-type PTT service and the second-type PTT service.

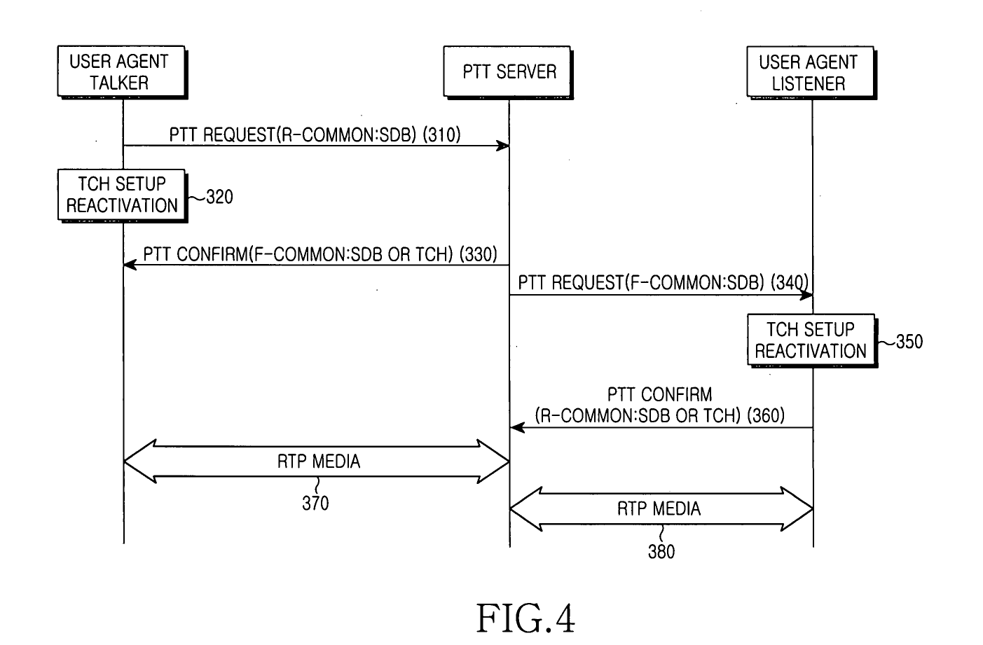

FIG. 4 is a message flow diagram illustrating a procedure for performing the first-type PTT service through a common channel according to a first embodiment of the present invention. Likewise, although such network elements as radio access networks and PDSNs are not illustrated herein, it should be understood that a message flow between a talker or listeners and a PTT server is achieved via corresponding radio access networks and PDSNs. Also, it should be noted that radio channels are connected between the talker or listeners and the radio access networks.

Referring to FIG. 4, a talker determines whether a traffic channel is currently connected in response to a push of a PTT button by a user. If the traffic channel is not connected (i.e., if the talker is in a dormant state), the talker transmits in step 310 a PTT request message “Can I get floor?” made in an SDB format to a PTT server over the R-EACH. Thereafter, in step 320, the talker immediately starts a procedure for setting up a traffic channel to a corresponding radio access network. Here, the set traffic channel is a fundamental channel (FCH) or a dedicated control channel (DCCH).

In step 330, the PTT server transmits a PTT confirm message “Grant/Deny” made in an SDB format or a message format for a general traffic channel to the talker over the F-CCCH to generate a grant tone. Thereafter, in step 340, the PTT server transmits a PTT request message “announce” having the SDB format to listeners over F-CCCH.

In step 350, the listeners perform a reactivation procedure with a corresponding radio access network in response to the PTT request message. If the setup of their traffic channels is completed by the reactivation procedure, the listeners transmit in step 360 a PTT confirm message “I am ready” to the PTT server over R-EACH. Then RTP voice packets can flow between the talker and the PTT server in step 370 and between the PTT server and the listeners in step 380.

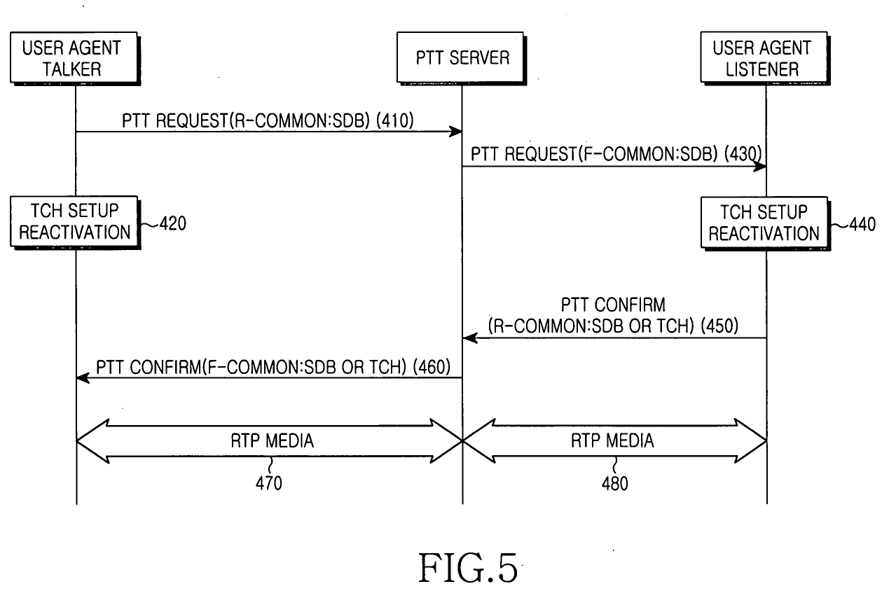

FIG. 5 is a message flow diagram illustrating a procedure for performing the second-type PTT service through a common channel according to a first embodiment of the present invention. Referring to FIG. 5, a talker determines whether a traffic channel is currently connected in response to a push of a PTT button by a user. If the traffic channel is not connected (i.e., if the talker is in a dormant state), the talker transmits in step 410 a PTT request message “Can I get floor?” having an SDB format to a PTT server over R-EACH. Thereafter, in step 420, the talker immediately starts a procedure for setting up a traffic channel to a corresponding radio access network. In step 430, the PTT server transmits a PTT request message “announce” having the SDB format to listeners over F-CCCH.

In step 440, the listeners perform a reactivation procedure with a corresponding radio access network in response to the PTT request message “announce.” If setup of their traffic channels is completed by the reactivation procedure, the listeners transmit in step 450 a PTT confirm message “I am ready” made in the SDB format or a message format for a general traffic channel to the PTT server over R-EACH. In step 460, the PTT server transmits a PTT confirm message “Grant/Deny” to the talker to generate a grant tone. Then RTP voice packets can be exchanged between the talker and the PTT server in step 470 and between the PTT server and the listeners in step 480.

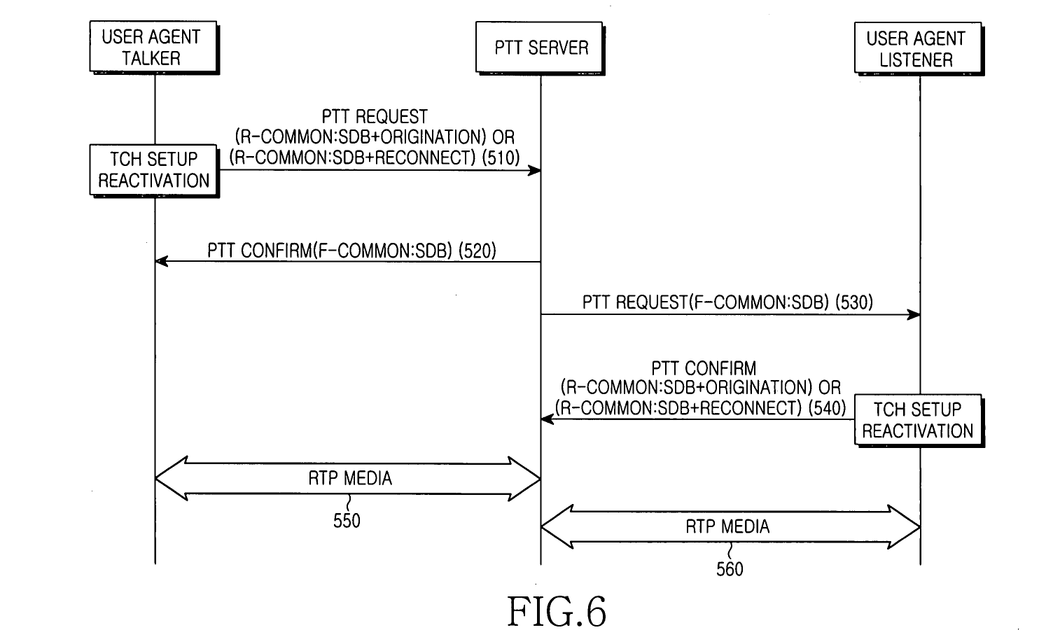

FIG. 6 is a message flow diagram illustrating a procedure for performing the first-type PTT service through a common channel according to a second embodiment of the present invention. Likewise, although such network elements as radio access networks and PDSNs are not illustrated herein, it should be understood that a message flow between a talker or listeners and a PTT server is achieved via corresponding radio access networks and PDSNs. Also, it should be noted that radio channels are connected between the talker or listeners and the radio access networks.

Referring to FIG. 6, a talker determines whether a traffic channel is currently connected in response to a push of a PTT button by a user. If the traffic channel is not connected (i.e., if the talker is in a dormant state), the talker transmits in step 510 a PTT request message “Can I get floor?” made in an SDB format, carried by an origination message (SDB+Origination) or a reconnect message (SDB+Reconnect), to a PTT server over the R-EACH, and performs a reactivation procedure for setting up a traffic channel to a corresponding radio access network. Here, the set traffic channel is a fundamental channel or a dedicated control channel.

Upon receiving the PTT request message “Can I get floor?,” the PTT server transmits in step 520 a PTT confirm message “Grant/Deny” having the SDB format to the talker over the F-CCCH to generate a grant tone. Thereafter, in step 530, the PTT server transmits a PTT request message “announce” having the SDB format to listeners over F-CCCH. In step 540, the listeners perform a reactivation procedure with a corresponding radio access network in response to the PTT request message. In reactivation procedure, in response, the listeners transmit a PTT confirm message “I am ready” having the SDB format, carried by an origination message or a reconnect message, to the PTT server over R-EACH. Then RTP voice packets can flow between the talker and the PTT server in step 550 and between the PTT server and the listeners in step 560.

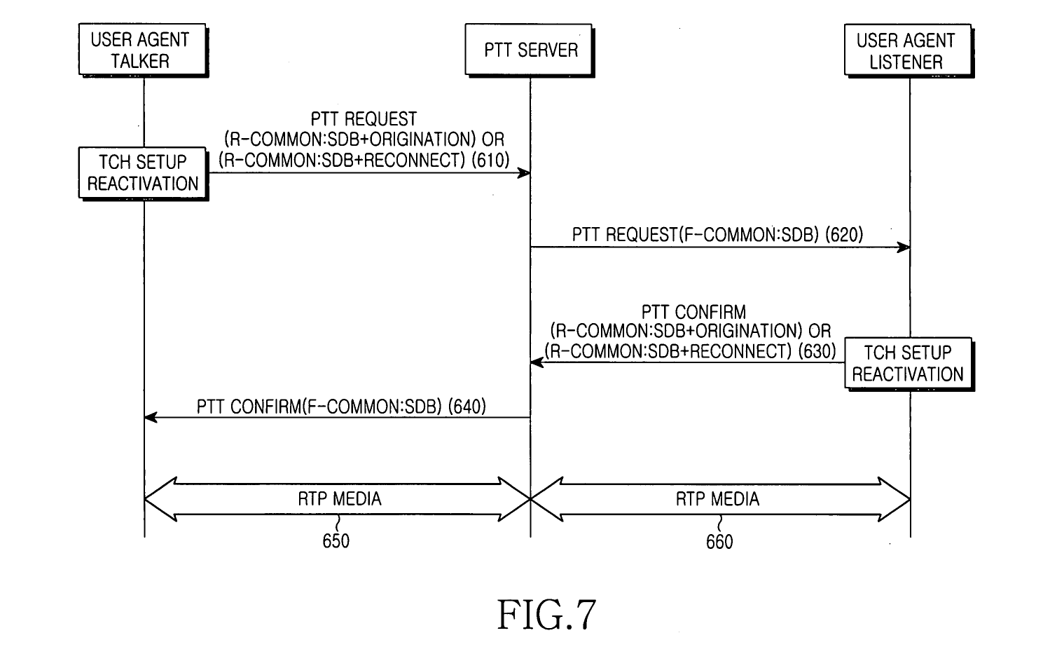

FIG. 7 is a message flow diagram illustrating a procedure for performing the second-type PTT service through a common channel according to a second embodiment of the present invention. Referring to FIG. 7, a talker determines whether a traffic channel is currently connected in response to a push of a PTT button by a user. If the traffic channel is not connected (i.e., if the talker is in a dormant state), the talker transmits in step 610 a PTT request message “Can I get floor?” having an SDB format, carried by an origination message (SDB+Origination) or a reconnect message (SDB+Reconnect), to a PTT server over R-EACH, and performs a reactivation procedure for setting up a traffic channel to a corresponding radio access network. In step 620, the PTT server transmits a PTT request message “announce” having the SDB format to listeners over F-CCCH.

In response to the PTT request message “announce,” the listeners transmit in step 630 a PTT confirm message “I am ready” having the SDB format, carried by an origination message or a reconnect message, to the PTT server over R-EACH, and perform a reactivation procedure with a corresponding radio access network. In step 640, the PTT server transmits a PTT confirm message “Grant/Deny” having the SDB format to the talker over F-CCCH to generate a grant tone. Then RTP voice packets can be exchanged between the talker and the PTT server in step 650 and between the PTT server and the listeners in step 660.

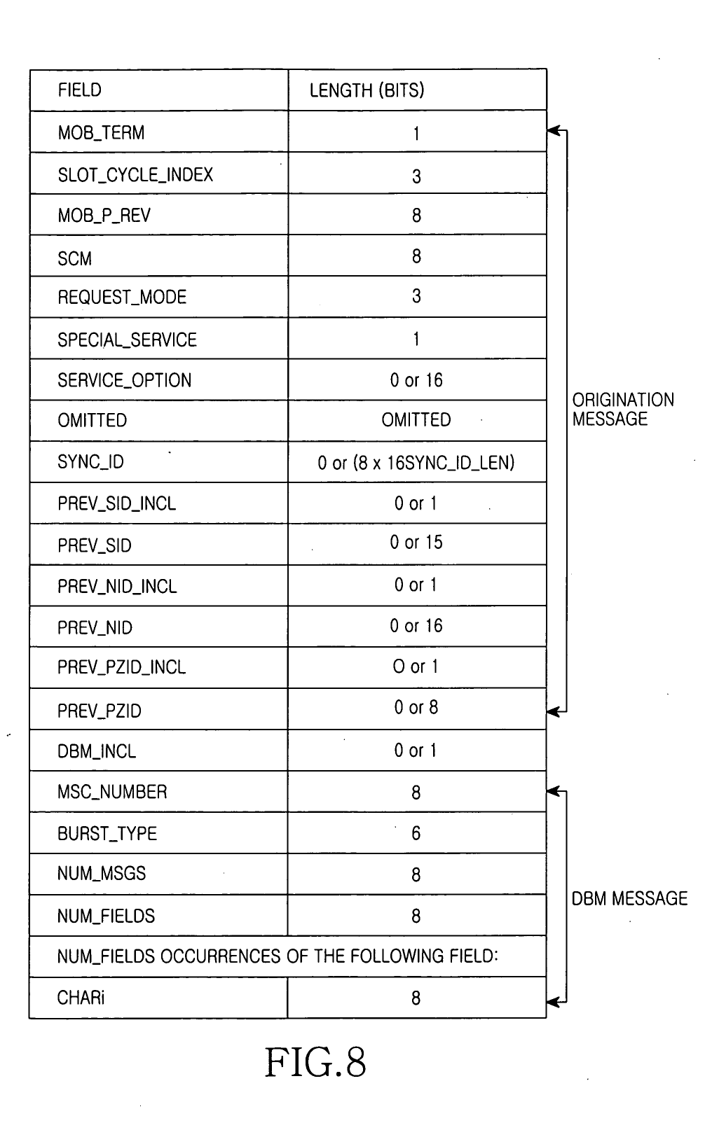

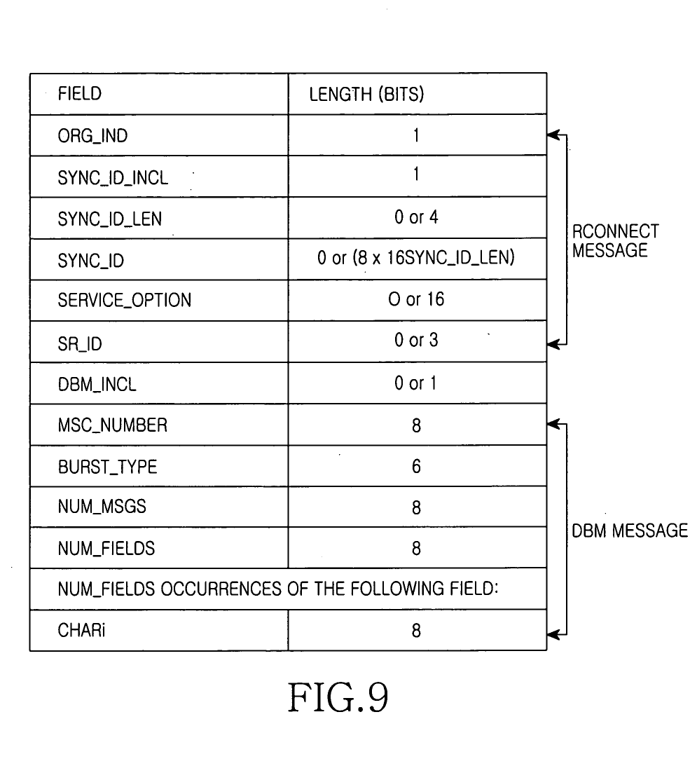

The origination message or the reconnect message used in the second embodiment of the present invention includes therein message fields for the SDB format. FIG. 8 is diagram illustrating a format of an origination message according to a second embodiment of the present invention, and FIG. 9 is a diagram illustrating a format of a reconnect message according to a second embodiment of the present invention.

As illustrated in FIGS. 8 and 9, the origination message and the reconnect message include a DBM_INCL field in addition to their unique fields indicating SERVICE_OPTION and the like. When the DBM_INCL field is ‘0’, DBM message fields are omitted, and when the DBM_INCL field is ‘1’, DBM message fields are included to piggyback PTT signal messages.

A description will now be made of major DBM message fields included in the origination message and the reconnect message. A BURST_TYPE field indicates a type of data contained therein, and a NUM_FIELDS field indicates the number of fields included in its following CHARi field. When the BURST_TYPE field has a predetermined value indicating a DBM type corresponding to a PTT signaling (request/confirm) message, the CHARi field includes the contents of a PTT request/confirm message a talker or a listener desires to transmit.

For a PTT service using a traffic channel and a PTT service using a common channel according to the embodiment of the present invention, latency required for PTT call setup is calculated separately in the following ways. Herein, in order to simplify calculation, internal processing latencies of a radio access network and a PTT server are disregarded. In addition, it is assumed that a time required for setting up a traffic channel is longer than a transmission time required when a PTT signaling message arrives at a PTT server.

PTT Service Using Traffic Channel=Ttch1+Trequest1+Tpaging+Ttch2+Trequest2+Tconfirm

Here, Ttch1 denotes a time period for a talker to set up a traffic channel, Trequest1 denotes a time period for a talker to transmit a PTT request message to a PTT server, Tpaging denotes a time period for a PTT server to page listeners, Ttch2 denotes a time period for listeners to set up their traffic channels, Trequest2 denotes a time period for a PTT server to transmit a PTT request message to listeners, and Tconfirm denotes a time period for listeners to transmit a PTT confirm message to a PTT server.

PTT Service Using Common Channel=Trequest1+Trequest2+Ttch

Here, Trequest1 denotes a time period for a talker to transmit a PTT request message to a PTT server, Trequest2 denotes a time period for a PTT server to transmits a PTT request message to listeners, and Ttch denotes a time period for listeners to set up their traffic channels.

It is noted from the foregoing description that call setup latency can be dramatically reduced by using a common channel.

As understood from the foregoing description, a PTT terminal attempts to set up a traffic channel while transmitting a PTT signaling message over a common channel to start a PTT service, or transmits a PTT signaling message carried by an origination message or a reconnect message transmitted over a common channel to set up a traffic channel, thereby efficiently reducing latency due to establishment of a traffic channel and an exchange of a PTT signaling message.

While the invention has been shown and described with reference to a certain embodiments thereof, it will be understood by those skilled in the art that various changes in form and details may be made therein without departing from the spirit and scope of the invention as defined by the appended claims. For example, although separate messages are defined herein for PTT signaling, it should be understood that the present invention proposes an efficient procedure on a radio interface for a PTT service and a management method of radio resources, and the invention uses not only the SIP but also another type of signaling.

What is claimed is:

1. A method for setting up a call for a Push-to-Talk (PTT) service in a cellular mobile communication system including at least two user agents, each of the user agents serving as a talker or a listener the method comprising the steps of:
transmitting a first PTT request message for initiating a PTT call to a PTT server over a reverse common channel, and connecting a traffic channel to a corresponding radio access network;
transmitting a second PTT request message to a listener in a dormant state over a forward common channel, and setting up a traffic channel to a corresponding radio access network in response to the second PTT request message;
setting up the traffic channel, and transmitting a PTT confirm message to the PTT server over a reverse common channel in response to the second PTT request message; and
transmitting voice packets to the listener over the set traffic channel via the PTT server.

2. The method of claim 1, further comprising the step of receiving the first PTT request message, and transmitting a PTT confirm message over a forward common channel in response to the first PTT request message to generate a grant tone before transmitting the second PTT request message to the listener.

3. The method of claim 1, further comprising the step of receiving a PTT confirm message having a short data burst (SDB) format from the listener in response to the second PTT request message, and transmitting a PTT confirm message to the talker over a forward common channel in response to the first PTT request message to generate a grant tone.

4. The method of claim 1, wherein the first and second PTT request messages have a short data burst (SDB) format.

5. The method of claim 2, wherein the PTT confirm messages have a short data burst (SDB) format or a message format for a traffic channel.

6. The method of claim 3, wherein the PTT confirm messages have the SDB format or a message format for a traffic channel.

7. The method of claim 1, wherein the step of setting up by the talker a traffic channel comprises the step of setting up a traffic channel through a reactivation procedure in a dormant state.

8. The method of claim 1, wherein the step of setting up by the listener a traffic channel comprises the step of setting up a traffic channel through a reactivation procedure in a dormant state.

9. The method of claim 1, wherein the reverse common channel is a reverse extended access channel.

10. The method of claim 2, wherein the forward common channel is a forward common control channel.

11. The method of claim 3, wherein the forward common channel is a forward common control channel.

12. A method for setting up a call for a Push-to-Talk (PTT) service in a cellular mobile communication system including at least two user agents, each of the user agents serving as a talker or a listener the method comprising the steps of:
transmitting a first PPT request message for starting a PTT call, carried by an origination message or a reconnect message, to a PTT server over a reverse common channel in order to set up a traffic channel to a corresponding radio access network;
transmitting a second PTT request message to a listener in a dormant state over a forward common channel, and setting up listener a traffic channel to a corresponding radio access network in response to the second PTT request message;
after setting up the traffic channel, transmitting a PTT confirm message carried by an origination message or a reconnect message to the PTT server over a reverse common channel in response to the second PTT request message; and
transmitting by the talker voice packets to the listener over the set traffic channel via.

13. The method of claim 12, further comprising the step of receiving the origination message or the reconnect message, and transmitting a PTT confirm message to the talker over a forward common channel in response to the first PTT request message to generate a grant tone before transmitting the second PTT request message to the listener.

14. The method of claim 12, further comprising the step of receiving a PTT confirm message having a short data burst (SDB) format from the listener in response to the second PTT request message, and transmitting a PTT confirm message to the talker over a forward common channel in response to the first PTT request message to generate a grant tone.

15. The method of claim 13, wherein the first and second PTT request messages and the PTT confirm messages have a short data burst (SDB) format.

16. The method of claim 14, wherein the first and second PTT request messages and the PTT confirm messages have the SDB format.

17. The method of claim 12, wherein the step of setting up by the talker a traffic channel comprises the step of setting up a traffic channel through a reactivation procedure in a dormant state.

18. The method of claim 12, wherein the step of setting up by the listener a traffic channel comprises the step of setting up a traffic channel through a reactivation procedure in a dormant state.

19. The method of claim 12, wherein the reverse common channel is a reverse extended access channel.

20. The method of claim 13, wherein the forward common channel is a forward common control channel.

21. The method of claim 14, wherein the forward common channel is a forward common control channel.

22. A mobile communication system for setting up a call for a Push-to-Talk (PTT) service, the system comprises:
a talker adapted to transmit a first PTT request message for initiating a PTT call over a reverse common channel, and setting up a traffic channel to a corresponding radio access network;
a PTT server adapted to receive the first PTT request message from the talker, transmit a second PTT request message to a listener in a dormant state over a forward common channel, and set up via the listener a traffic channel to a corresponding radio access network in response to the second PTT request message;
the listener being further adapted to set up the traffic channel, and transmit a PTT confirm message to the PTT server over the reverse common channel in response to the second PTT request message and receive transmitted voice packets from the talker over the set traffic channel via the PTT server.

23. The system of claim 22, wherein the PTT server is further adapted to receive the first PTT request message, and transmit a PTT confirm message to the talker over a forward common channel in response to the first PTT request message to generate a grant tone before transmitting the second PTT request message to the listener.

24. The system of claim 22, wherein the PTT server is further adapted to receive a PTT confirm message having a short data burst (SDB) format from the listener in response to the second PTT request message, and transmit a PTT confirm message to the talker over a forward common channel in response to the first PTT request message to generate a grant tone.

25. The system of claim 22, wherein the first and second PTT request messages have a short data burst (SDB) format.

26. The system of claim 23, wherein the PTT confirm messages have a short data burst (SDB) format or a message format for a traffic channel.

27. The system of claim 24, wherein the PTT confirm messages have the SDB format or a message format for a traffic channel.

28. The system of claim 22, wherein the talker is further adapted to set up a traffic channel through a reactivation procedure in a dormant state.

29. The system of claim 22, wherein the listener is further adapted to set up a traffic channel through a reactivation procedure in a dormant state.

30. The system of claim 22, wherein the reverse common channel is a reverse extended access channel.

31. The system of claim 23, wherein the forward common channel is a forward common control channel.

32. The system of claim 24, wherein the forward common channel is a forward common control channel.

33. The system of claim 22, wherein the talker comprises a user agent.

34. The system of claim 22, wherein the talker includes a button for making the PTT call.

35. The system of claim 22, wherein the radio access network connects the talker and listener to a packet communication network.

36. The system of claim 22, wherein the mobile communication network comprises a cellular network.

37. The system of claim 22, wherein the listener comprises a user agent.
